(19) United States
(12) Patent Application Publication
(10) Pub. No.: US 2020/0130563 A1
(43) Pub. Date: Apr. 30, 2020

(54) HEADLAMP CONTROL APPARATUS AND METHOD

(71) Applicant: HYUNDAI MOBIS CO., LTD., Seoul (KR)

(72) Inventor: Jun Young Sung, Yongin-si (KR)

(21) Appl. No.: 16/665,192

(22) Filed: Oct. 28, 2019

(30) Foreign Application Priority Data
Oct. 29, 2018 (KR) 10-2018-0129888

(51) Int. Cl. B60Q 1/14; G06K 9/00

(52) U.S. Cl. CPC B60Q 1/143; G06K 9/00798; G01S 19/42; B60Q 2300/32; B60Q 2300/45

(57) ABSTRACT

A headlamp control apparatus includes: a headlamp configured to emit light having a high beam pattern in a forward direction from a vehicle; an image capturing unit configured to capture a surrounding image of the vehicle, the surrounding image of the vehicle referring to an image of a peripheral environment of the vehicle; a median barrier detection unit configured to detect a presence of a median barrier around the vehicle, by using information obtained from the surrounding image; and a lamp controller configured to control the light of the headlamp in response to detecting the presence of the median barrier and determining that the vehicle is close to the median barrier.

### CROSS-REFERENCE TO RELATED APPLICATION

This application claims priority from and the benefit of Korean Patent Application No. 10-2018-0129888, filed on Oct. 29, 2018, which is hereby incorporated by reference for all purposes as if set forth herein.

### BACKGROUND

### Field

Exemplary embodiments relate to a headlamp control apparatus and method for preventing glare to an opposite vehicle and dazzle to a driver by controlling light of a headlamp in a median barrier section of a lane.

### Discussion of the Background

A front camera, which is a main recognition device of an adaptive driving beam (ADB) for night driving convenience, detects the presence or absence of a vehicle based on a head and rear light source pair, but a current system depending on camera image processing causes some problems.

In a general high-speed road, a median strip is provided to separate an opposite vehicle and a preceding vehicle, and some open steel structures allow a light source of an opposite vehicle to quickly repeat the exposure and non-exposure cycles during real road driving. Therefore, a camera based on light source recognition enters a situation where misrecognition inevitably occurs in a corresponding section, and may cause dazzle to a driver due to frequent turning-on and off. Furthermore, a median strip having a fully-enclosed cement structure may cause direct glare because it is not recognized by high trucks, buses or the like.

During real road driving, since a plurality of median strips exist not only on a highway (or an interstate highway) but also on a national road (or a state highway), the ADB of own vehicle may cause serious safety problems in the section of the median strip of the national road.

Since the background art described above is technical information possessed by the inventor for the derivation of the present disclosure or acquired in the derivation process of the present disclosure, it may not be said to be a publicly known technique disclosed to the general public before filing the application for the present disclosure.

The related art of the present disclosure is disclosed in Korean Patent No. 10-1675308.

The above information disclosed in this Background section is only for enhancement of understanding of the background of the invention and, therefore, it may contain information that does not constitute prior art.

### SUMMARY

Exemplary embodiments of the present invention are directed to maximizing beam pattern efficiency of a headlamp while preventing glare to an opposite vehicle and dazzle to a driver by controlling light of the headlamp in a median barrier section of a driving lane.

Additional features of the invention will be set forth in the description which follows, and in part will be apparent from the description, or may be learned by practice of the invention.

According to the exemplary embodiments of the current disclosure, a headlamp control apparatus includes: a headlamp configured to emit light having a high beam pattern in a forward direction from a vehicle; an image capturing unit configured to capture a surrounding image of the vehicle, the surrounding image of the vehicle referring to an image of a peripheral environment of the vehicle; a median barrier detection unit configured to detect a presence of a median barrier around the vehicle, by using information obtained from the surrounding image; and a lamp controller configured to control the light of the headlamp in response to detecting the presence of the median barrier and determining that the vehicle is close to the median barrier.

The headlamp control apparatus may further include: a road information determination unit configured to determine whether a type of a road on which the vehicle is currently being driven is a state highway or an interstate highway based on GPS information of the vehicle, wherein the lamp controller may be configured to control the light of the headlamp in response to determining that the vehicle is driving on one of the state highway and the interstate highway.

The headlamp may include: a first headlamp configured to emit first light having a left beam pattern with respect to a driving lane area; and a second headlamp configured to emit second light having a right beam pattern with respect to the driving lane area.

The lamp controller may be configured to turn off one of the first headlamp and the second headlamp which is closer to the median barrier, in response to: determining that the vehicle is driving on one of the state highway and the interstate highway; detecting the presence of the median barrier around the vehicle; and determining that the vehicle is close to the median barrier.

The GPS information may include information indicating whether the road on which the vehicle is currently driving is a left-hand drive road or a right-hand drive road, and the lamp controller may be configured to turn off the first headlamp and maintain emission of the second light of the second headlamp, in response to: determining that the vehicle is driving on one of the state highway and the interstate highway; determining that the vehicle is driving on the left-hand drive road; detecting the presence of the median barrier on a left side of the vehicle; and determining that the vehicle is close to the median barrier.

The lamp controller may be configured to maintain emission of the first light of the first headlamp and turn off the second headlamp, in response to: determining that the vehicle is driving on one of the state highway and the interstate highway; determining that the vehicle is driving on the right-hand drive road; detecting the presence of the median barrier on a right side of the vehicle; and determining that the vehicle is close to the median barrier.

According to the exemplary embodiments of the current disclosure, a headlamp control method includes: emitting, by a headlamp, light having a high beam pattern in a forward direction from a vehicle; capturing, by an image capturing unit, a surrounding image of the vehicle, the surrounding image of the vehicle referring to an image of a peripheral environment of the vehicle; detecting, by a median barrier detection unit, a presence of a median barrier around the vehicle by using information obtained from the surrounding image of the vehicle; and controlling, by a lamp controller, the light of the headlamp in response to detecting the presence of the median barrier and determining that the vehicle is close to the median barrier.

The headlamp control method further include: determining, by a road information determination unit, whether a type of a road on which the vehicle is currently being driven is a state highway or an interstate highway based on GPS information of the vehicle, wherein the controlling the light of the light of the headlamp may include controlling, by the lamp controller, the light of the headlamp in response to determining that the vehicle is driving on one of the state highway and the interstate highway.

The headlamp may include a first headlamp and a second headlamp, and the emitting of the light having a high beam pattern may include: emitting, by a first headlamp, first light having a left beam pattern to a driving lane area; and emitting, by a second headlamp, second light having a right beam pattern to the driving lane area.

The controlling of the light of the headlamp may include: turning off one of the first headlamp and the second headlamp which is closer to the median barrier, in response to: determining that the vehicle is driving on one of the state highway and the interstate highway; detecting the presence of the median barrier around the vehicle; and determining that the vehicle is close to the median barrier.

The GPS information may include information indicating whether the road on which the vehicle is currently driving is a left-hand drive road or a right-hand drive road, and wherein the controlling of the light of the headlamp may include turning off the first headlamp and maintaining emission of the second light of the second headlamp, in response to: determining that the vehicle is driving on one of the state highway and the interstate highway; determining that the vehicle is driving on the left-hand drive road; detecting the presence of the median barrier on a left side of the vehicle; and determining that the vehicle is close to the median barrier.

The controlling of the light of the headlamp may include maintaining emission of the first light of the first headlamp and turning off the second headlamp in response to: determining that the vehicle is driving on one of the state highway and the interstate highway; determining that the vehicle is driving on the right-hand drive road; detecting the presence of the median barrier on a right side of the vehicle; and determining that the vehicle is close to the median barrier.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram for schematically explaining a headlamp control apparatus in accordance with an embodiment of the present disclosure.

FIG. 2 is a diagram for schematically explaining a detailed configuration of a controller of the headlamp control apparatus of FIG. 1.

FIGS. 3A, 3B, 4A, and 4B are diagrams for schematically explaining a headlamp control situation.

FIG. 5 is a flowchart for explaining a headlamp control method in accordance with an embodiment of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, exemplary embodiments of the present invention will be described in more detail with reference to the accompanying drawings.

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, a headlamp control apparatus and method will be described below with reference to the accompanying drawings through various examples of embodiments. The advantages and features of the present disclosure and methods for achieving them will become readily apparent by reference to the following detailed description when considered in conjunction with the accompanying drawings. However, the present disclosure is not limited to embodiments to be described below, may be realized in various forms, and should be construed to include all modifications, equivalents, and alternatives falling within the spirit and scope of the disclosure. The embodiments to be described below are provided to bring the disclosure of the present disclosure to perfection and assist those skilled in the art to completely understand the scope of the present disclosure in the technical field to which the present disclosure pertains. Detailed descriptions related to well-known functions or configurations will be ruled out in order not to unnecessarily obscure subject matters of the present disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. The terms such as first and second may be used to describe various components, but the components are not limited by the terms, and the terms are used only to distinguish one component from another component.

Hereafter, embodiments in accordance with the present disclosure will be described in detail with reference to the accompanying drawings. In the description with reference to the accompanying drawings, same or corresponding components are denoted by the same reference numerals and redundant description thereof will be omitted.

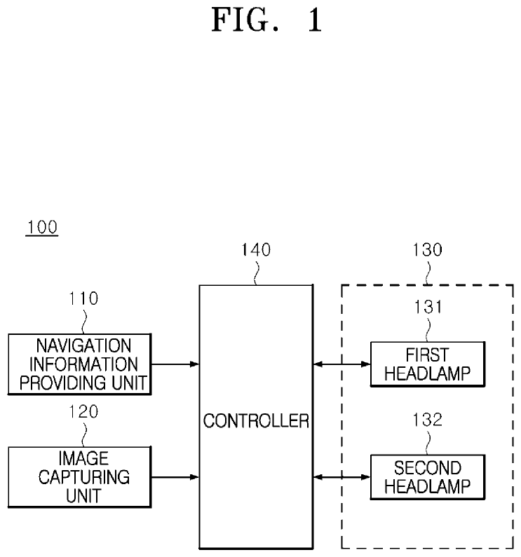

FIG. 1 is a diagram for schematically explaining a headlamp control apparatus in accordance with an embodiment of the present disclosure. Referring to FIG. 1, a headlamp control apparatus 100 may include a navigation information providing unit 110, an image capturing unit 120, a headlamp 130, and a controller 140.

The navigation information providing unit 110 may grasp the current position of a vehicle in interlocking with a plurality of global positioning systems (GPS) (not illustrated), and provide navigation information including graphic information and voice guidance for a route from a departure to a destination of the vehicle. The navigation information may include information regarding a road on which the vehicle is currently located, information regarding the current position of the vehicle that is driving, the name or the type of the road on which the vehicle that is driving is currently located, whether the vehicle has passed a highway tollgate, and the position of a highway rest area, or the like. Furthermore, the type of the road may conform to the definition by various laws such as Article 2 of the Road Act and Article 8 of the Road Act, and may also be classified according to predetermined setting. According to the predetermined setting, the type of the road, for example, may be classified into a highway (or an interstate highway), a general national road (or a state highway), and a downtown road (or a local road). Moreover, the navigation information may include information regarding whether the road on which the vehicle is currently driving is a left-hand drive road or a right-hand drive road.

The image capturing unit 120 may generate an image frame by capturing a surrounding image of the vehicle that is driving, and grasp lane information indicating whether a lane in which the vehicle is currently driving is the first lane or the second lane, information indicating whether the lane is marked by a solid line, a dotted line, or a double line, information on the color of the lane, sign information, information on the presence or absence of a median barrier (for example, a median strip or the like) located around the vehicle, information on the position of the median barrier, or the like, by using the generated image frame and the navigation information.

Such an image capturing unit 120 may include a camera provided in a vehicle to capture an image frame around the vehicle. The camera, for example, refers to a camera that captures a subject in a capturing area by using a complementary metal-oxide semiconductor (CMOS) module (not illustrated), a charge coupled device (CCD) module (not illustrated), or the like. An inputted image frame is provided to the CMOS module or the CCD module through a lens (not illustrated) and the CMOS module or the CCD module may convert an optical signal of the subject having passed through the lens into an electrical signal for output. Such a camera is provided therein with an image signal processing unit (not illustrated) capable of reducing noise of the captured image frame and performing image signal processing for improving image quality such as gamma correction, color filter array interpolation, color matrix, color correction, color enhancement.

The headlamp 130 may be installed in the vehicle to emit light having a predetermined beam pattern. Specifically, the headlamp 130 may be installed on a front side of the vehicle to ensure the frontal visual field when driving at night or driving in a dark place such as a tunnel. Furthermore, in an embodiment, the headlamp 130 may ensure a far field of vision by emitting light of a high beam pattern, and a low beam pattern for ensuring a near field of vision may be formed together with the high beam pattern.

In the present embodiment, the headlamp 130 may include a first headlamp 131 and a second headlamp 132, wherein the first headlamp 131 is a left headlamp and may emit light of a left beam pattern to a driving lane area and the second headlamp 132 is a right headlamp and may emit light of a right beam pattern to the driving lane area. During the emission of the light of the high beam pattern, any one of the first headlamp 131 and the second headlamp 132 may emit the light to an opposing lane area to cause glare to a driver who is driving in the opposing lane, resulting in the occurrence of safety problems.

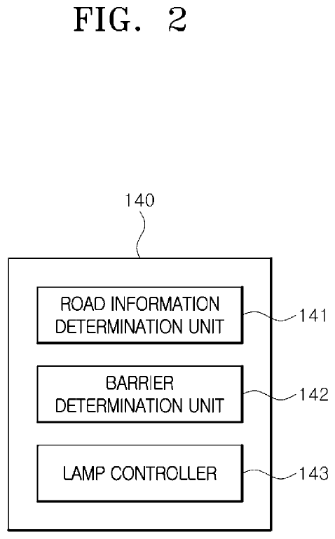

The controller 140 may control the turning-on/off the headlamp 130 by using the navigation information provided by the navigation information providing unit 110 and the information on the image frame captured by the image capturing unit 120. FIG. 2 is a diagram for schematically explaining a detailed configuration of the controller 140 of the headlamp control apparatus of FIG. 1, and the controller 140 may include a road information determination unit 141, a median barrier detection unit 142, and a lamp controller 143.

The road information determination unit 141 may determine whether a road on which the vehicle is currently driving is one of a national road (or a local road) and a highway by using the vehicle navigation information provided by the navigation information providing unit 110. Furthermore, the road information determination unit 141 may determine whether the road on which the vehicle is driving is a left-hand drive road or a right-hand drive road by using the vehicle navigation information provided by the navigation information providing unit 110. For example, South Korea, United States of America or the like have the left-hand drive road environment, and Australia, Japan or the like have the right-hand drive road environment.

The median barrier detection unit 142 may determine the presence or absence of a median barrier located around the driving vehicle by using the information on the image frame around the vehicle captured by the image capturing unit 120. The present embodiment discloses that the median barrier detection unit 142 determines the presence or absence of the median barrier by using the information on the image frame around the vehicle captured by the image capturing unit 120; however, the present disclosure is not limited thereto and it may also be possible to determine the presence or absence of the median barrier by using a radar or LiDAR oscillation and reception signal of a radar sensor (not illustrated) or a LiDAR sensor (not illustrated).

The lamp controller 143 may control the light of the headlamp 130 when the vehicle is driving on any one of the national road and the highway, there is the median barrier around the vehicle, and the vehicle is close to the median barrier. The detection on the case where the vehicle is close to the median barrier may be based on information on the number of lanes at the current position of the vehicle based on the navigation information, whether a lane in which the vehicle is currently driving is a lane adjacent to the median barrier through adjacent lane information based on the image frame information around the vehicle, and information on the shape (dotted line, solid line, or double line) of the lane. Furthermore, controlling the light of the headlamp 130 may include turning off any one of the first headlamp 131 and the second headlamp 132, which is close to the median barrier, and maintaining light emission (turning on) of the other one.

In a selective embodiment, when the vehicle is driving on any one of the national road and the highway, the position of the median barrier is determined depending on whether the road on which the vehicle is driving is a left-hand drive road or a right-hand drive road, and the vehicle is close to the median barrier, the lamp controller 143 may control the light of the headlamp 130. When the vehicle is driving on any one of the national road and the highway, the road on which the vehicle is driving is the left-hand drive road, the median barrier is present on the left side of the vehicle, and the vehicle is close to the median barrier, the lamp controller 143 may control the first headlamp 131 to be turned off and the light emission of the second headlamp 132 to be maintained. When the vehicle is driving on any one of the national road and the highway, the road on which the vehicle is driving is the right-hand drive road, the median barrier is present on the right side of the vehicle, and the vehicle is close to the median barrier, the lamp controller 143 may control the light emission of the first headlamp 131 to be maintained and the second headlamp 132 to be turned off.

In a selective embodiment, when the vehicle is driving on any one of the national road and the highway, the median barrier is present around the vehicle, and the vehicle is close to the median barrier, the lamp controller 143 may control any one close to the median barrier between the first headlamp 131 and the second headlamp 132, which are emitting a high beam, to emit a low beam and control the other one to maintain a high beam emission state.

In a selective embodiment, when the vehicle is driving on any one of the national road and the highway, the road on which the vehicle is driving is the left-hand drive road, the median barrier is present on the left side of the vehicle, and the vehicle is close to the median barrier, the lamp controller 143 may control the first headlamp 131 to emit a low beam and control the second headlamp 132 to maintain a high beam emission state. When the vehicle is driving on any one of the national road and the highway, the road on which the vehicle is driving is the left-hand drive road, the median barrier is present on the right side of the vehicle, and the vehicle is close to the median barrier, the lamp controller 143 may control the first headlamp 131 to maintain a high beam emission state and control the second headlamp 132 to emit a low beam.

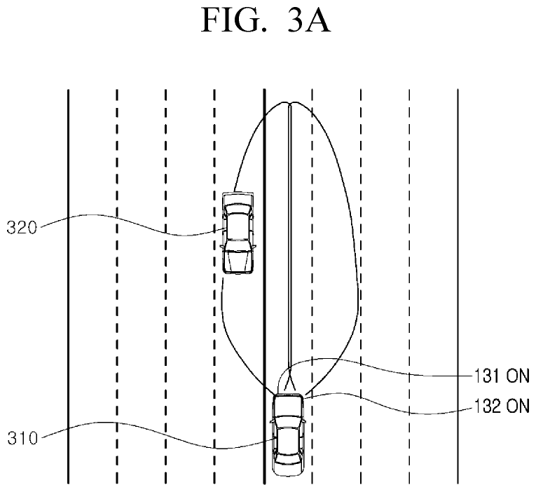

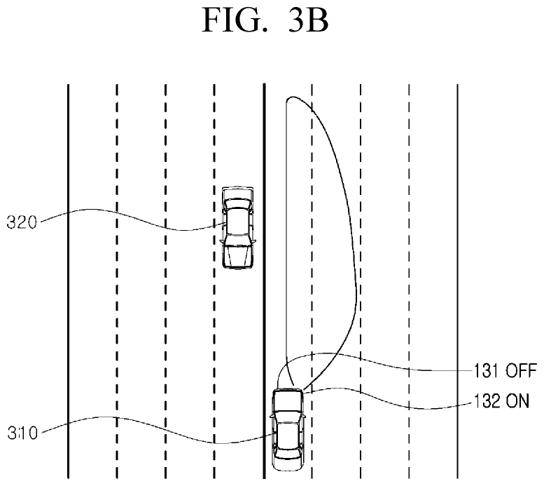

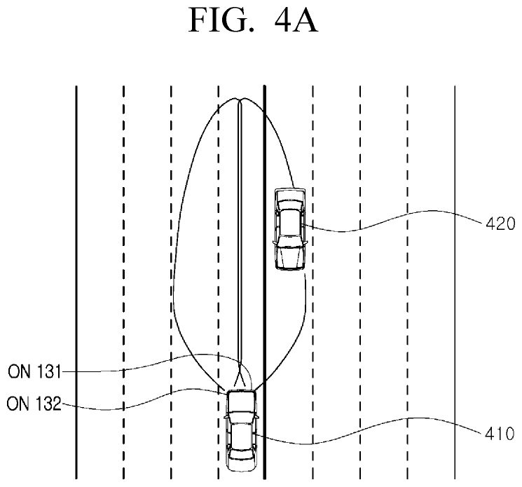

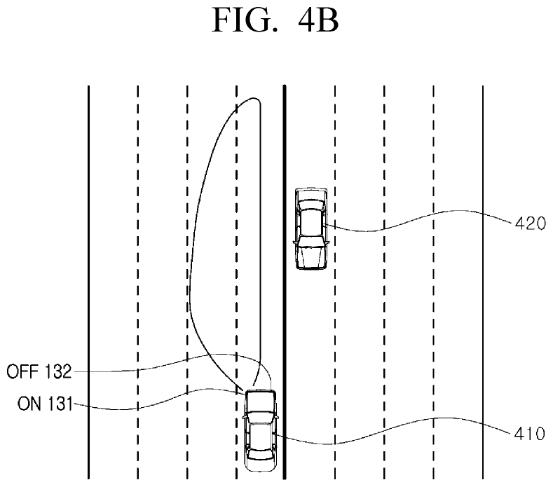

FIGS. 3A, 3B, 4A, and 4B are diagrams for schematically explaining a headlamp control situation. Referring to FIGS. 3A and 3B, FIG. 3A illustrates a state in which, when a vehicle 310 is driving on any one of a national road and a highway, a road on which the vehicle 310 is driving is a left-hand drive road, a median barrier is present on the left side of the vehicle 310, and the vehicle 310 is close to the median barrier, both the first headlamp 131 and the second headlamp 132 of the vehicle 310 emit light (are turned on), thereby causing glare to a driver of an opposite vehicle 320. FIG. 3B illustrates a state in which, from the state of FIG. 3A, the first headlamp 131 of the vehicle 310 is turned off and the second headlamp 132 emits light (is turned on) under the control of the lamp controller 143, thereby causing no glare to the driver of the opposite vehicle 320.

Referring to FIGS. 4A and 4B, FIG. 4A illustrates a state in which, when a vehicle 410 is driving on any one of the national road and the highway, a road on which the vehicle 410 is driving is a right-hand drive road, a median barrier is present on the right side of the vehicle 410, and the vehicle 410 is close to the median barrier, both the first headlamp 131 and the second headlamp 132 of the vehicle 410 emit light (are turned on), thereby causing glare to a driver of an opposite vehicle 420. FIG. 4B illustrates a state in which, from the state of FIG. 4A, the first headlamp 131 of the vehicle 410 emits light (is turned on) and the second headlamp 132 is turned off under the control of the lamp controller 143, thereby causing no glare to the driver of the opposite vehicle 420.

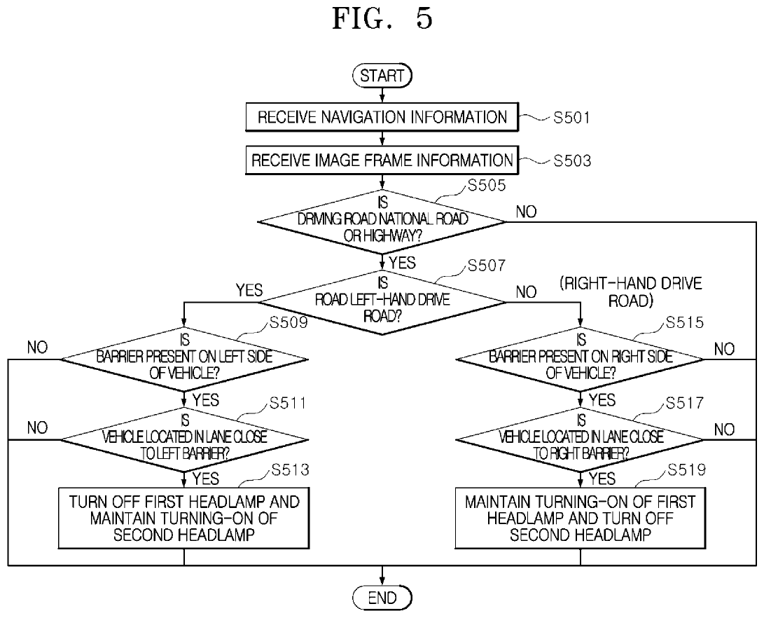

FIG. 5 is a flowchart for explaining a headlamp control method in accordance with an embodiment of the present disclosure. In the following description, description of parts overlapping the description of FIGS. 1, 2, 3A, 3B, 4A, and 4B will be omitted.

Referring to FIG. 5, in step S501, the controller 140 receives the navigation information related to the vehicle from the navigation information providing unit 110.

In step S503, the controller 140 receives the image frame information from the image capturing unit 120.

In step S505, the controller 140 determines from the navigation information whether a road on which the vehicle is currently driving is a national road or a highway.

In step S507, when the road on which the vehicle is currently driving is the national road or the highway, the controller 140 determines whether the road on which the vehicle is driving is a left-hand drive road.

In step S509, when the road on which the vehicle is currently driving is the national road or the highway and the road on which the vehicle is driving is the left-hand drive road, the controller 140 determines whether a median barrier is present on the left side of the vehicle.

In step S511, when the road on which the vehicle is currently driving is the national road or the highway, the road on which the vehicle is driving is the left-hand drive road, and the median barrier is present on the left side of the vehicle, the controller 140 determines whether the vehicle is located in a lane close to the left median barrier.

In step S513, when the road on which the vehicle is currently driving is the national road or the highway, the road on which the vehicle is driving is the left-hand drive road, the median barrier is present on the left side of the vehicle, and the vehicle is located in the lane close to the left median barrier, the controller 140 turns off the first headlamp 131 and maintains turning-on of the second headlamp 132. In the left-hand drive road, the first headlamp 131 of the vehicle, which is driving in the lane (for example, the first lane) close to the median barrier of the national road or the highway, is turned off, thereby causing no glare to a driver of an opposite vehicle.

In step S515, when the road on which the vehicle is currently driving is the national road or the highway and the road on which the vehicle is driving is a right-hand drive road, the controller 140 determines whether a median barrier is present on the right side of the vehicle.

In step S517, when the road on which the vehicle is currently driving is the national road or the highway, the road on which the vehicle is driving is the right-hand drive road, and the median barrier is present on the right side of the vehicle, the controller 140 determines whether the vehicle is located in a lane close to the right median barrier.

In step S519, when the road on which the vehicle is currently driving is the national road or the highway, the road on which the vehicle is driving is the right-hand drive road, the median barrier is present on the right side of the vehicle, and the vehicle is located in the lane close to the right median barrier, the controller 140 maintains turning-on of the first headlamp 131 and turns off the second headlamp 132. In the right-hand drive road, the second headlamp 132 of the vehicle, which is driving in the lane (for example, the first lane) close to the median barrier of the national road or the highway, is turned off, thereby causing no glare to a driver of an opposite vehicle.

According to the exemplary embodiments, a highway mode, which contributes to preventing dazzle to a driver of own vehicle and glare to an opposite vehicle, is extended to a national road, so that it is possible to remove all issues caused by a median barrier.

Furthermore, it is possible to directly contribute to improving a driver's visibility and reducing dazzle by controlling light of the headlamp in a median barrier section of a driving lane.

Although a preferred embodiment of the invention has been disclosed for illustrative purposes, those skilled in the art will appreciate that various modifications and equivalent other embodiments are possible, without departing from the scope of the invention as defined in the accompanying claims.

What is claimed is:

1. A headlamp control apparatus comprising:
a headlamp configured to emit light having a high beam pattern in a forward direction from a vehicle;
an image capturing unit configured to capture a surrounding image of the vehicle, the surrounding image of the vehicle referring to an image of a peripheral environment of the vehicle;
a median barrier detection unit configured to detect a presence of a median barrier around the vehicle, by using information obtained from the surrounding image; and
a lamp controller configured to control the light of the headlamp in response to detecting the presence of the median barrier and determining that the vehicle is close to the median barrier.

2. The headlamp control apparatus of claim 1, further comprising:
a road information determination unit configured to determine whether a type of a road on which the vehicle is currently being driven is a state highway or an interstate highway based on GPS information of the vehicle,
wherein the lamp controller is configured to control the light of the headlamp in response to determining that the vehicle is driving on one of the state highway and the interstate highway.

3. The headlamp control apparatus of claim 2, wherein the headlamp comprises:
a first headlamp configured to emit first light having a left beam pattern with respect to a driving lane area; and
a second headlamp configured to emit second light having a right beam pattern with respect to the driving lane area.

4. The headlamp control apparatus of claim 3, wherein the lamp controller is configured to turn off one of the first headlamp and the second headlamp which is closer to the median barrier, in response to:
determining that the vehicle is driving on one of the state highway and the interstate highway;
detecting the presence of the median barrier around the vehicle; and
determining that the vehicle is close to the median barrier.

5. The headlamp control apparatus of claim 4, wherein the GPS information comprises information indicating whether the road on which the vehicle is currently driving is a left-hand drive road or a right-hand drive road, and
the lamp controller is configured to turn off the first headlamp and maintain emission of the second light of the second headlamp, in response to:
determining that the vehicle is driving on one of the state highway and the interstate highway;
determining that the vehicle is driving on the left-hand drive road;
detecting the presence of the median barrier on a left side of the vehicle; and
determining that the vehicle is close to the median barrier.

6. The headlamp control apparatus of claim 5, wherein the lamp controller is configured to maintain emission of the first light of the first headlamp and turn off the second headlamp, in response to:
determining that the vehicle is driving on one of the state highway and the interstate highway;
determining that the vehicle is driving on the right-hand drive road;
detecting the presence of the median barrier on a right side of the vehicle; and
determining that the vehicle is close to the median barrier.

7. A headlamp control method, comprising:
emitting, by a headlamp, light having a high beam pattern in a forward direction from a vehicle;
capturing, by an image capturing unit, a surrounding image of the vehicle, the surrounding image of the vehicle referring to an image of a peripheral environment of the vehicle;
detecting, by a median barrier detection unit, a presence of a median barrier around the vehicle by using information obtained from the surrounding image of the vehicle; and
controlling, by a lamp controller, the light of the headlamp in response to detecting the presence of the median barrier and determining that the vehicle is close to the median barrier.

8. The headlamp control method of claim 7, further comprising:
determining, by a road information determination unit, whether a type of a road on which the vehicle is currently being driven is a state highway or an interstate highway based on GPS information of the vehicle,
wherein the controlling the light of the light of the headlamp comprises controlling, by the lamp controller, the light of the headlamp in response to determining that the vehicle is driving on one of the state highway and the interstate highway.

9. The headlamp control method of claim 8, wherein the headlamp comprises a first headlamp and a second headlamp, and
wherein the emitting of the light having a high beam pattern comprises:
emitting, by a first headlamp, first light having a left beam pattern to a driving lane area; and
emitting, by a second headlamp, second light having a right beam pattern to the driving lane area.

10. The headlamp control method of claim 9, wherein the controlling of the light of the headlamp comprises:
turning off one of the first headlamp and the second headlamp which is closer to the median barrier, in response to:
determining that the vehicle is driving on one of the state highway and the interstate highway;
detecting the presence of the median barrier around the vehicle; and
determining that the vehicle is close to the median barrier.

11. The headlamp control method of claim 10, wherein the GPS information comprises information indicating whether the road on which the vehicle is currently driving is a left-hand drive road or a right-hand drive road, and
wherein the controlling of the light of the headlamp comprises turning off the first headlamp and maintaining emission of the second light of the second headlamp, in response to:
determining that the vehicle is driving on one of the state highway and the interstate highway;
determining that the vehicle is driving on the left-hand drive road;
detecting the presence of the median barrier on a left side of the vehicle; and
determining that the vehicle is close to the median barrier.

12. The headlamp control method of claim 11, wherein the controlling of the light of the headlamp comprises maintaining emission of the first light of the first headlamp and turning off the second headlamp in response to:
determining that the vehicle is driving on one of the state highway and the interstate highway;
determining that the vehicle is driving on the right-hand drive road;
detecting the presence of the median barrier on a right side of the vehicle; and
determining that the vehicle is close to the median barrier.
